(19) United States
(12) Patent Application Publication
(10) Pub. No.: US 2025/0303503 A1
(43) Pub. Date: Oct. 2, 2025

(54) BRAZED HYBRID ALUMINUM/COPPER HEAT EXCHANGERS

(71) Applicant: Dana Canada Corporation, Oakville (CA)

(72) Inventors: Andrei CATUNEANU, Burlington (CA); Feng LIANG, Oakville (CA)

(21) Appl. No.: 18/621,970

(22) Filed: Mar. 29, 2024

(51) Int. Cl. B23K 35/02; B23K 1/00; B23K 35/28; B23K 101/14; B23K 103/10; B23K 103/12

(52) U.S. Cl. CPC B23K 35/0238; B23K 1/0012; B23K 35/286; B23K 2101/14; B23K 2103/10; B23K 2103/12

(57) ABSTRACT

Systems relate to a processed braze sheet (PBS) for a heat exchanger. In one example, a processed braze sheet (PBS) comprises at least a layer of aluminum (Al) with at least one side clad and a melting point depressant (MPD) layer comprising copper (Cu). The layer of Al is clad on at least one side with a metal comprising a melting point lower than Al.

### TECHNICAL FIELD

The present description relates generally to methods and systems for hybrid aluminum/copper heat exchangers.

### BACKGROUND AND SUMMARY

Heat exchangers may be formed of either aluminum (Al)/alloys of aluminum or copper (Cu)/alloys of copper. For some applications, Cu and/or alloys of copper may be preferred for higher thermal conductivity when compared to the thermal conductivity of Al and/or alloys of aluminum. However, Cu is heavier and more expensive than Al. For applications where cost and/or weight reductions are demanded, such as heat exchangers in vehicles, heat exchangers may include Al and/or alloys thereof to decrease cost and weight despite having a lower thermal conductivity.

Inventors have herein devised a solution to at least partially address the above problem. In one example, a system for a processed braze sheet (PBS) includes a processed braze sheet (PBS) including at least a layer of aluminum (Al) or aluminum alloy with at least one side comprising a melting point depressant (MPD) layer comprising copper (Cu). In this way, the low costs of Al may be utilized while the benefits of Cu are realized.

In one example, the MPD layer may be coated with a braze promoting (BP) layer. The BP layer may include one or more of nickel (Ni), cobalt (Co), and iron (Fe). The BP layer may be coated with a viscosity and/or a surface tension modifying (VM) layer comprising one or more of bismuth (Bi), lead (Pb), tin (Sn), antimony (Sb), and thallium (Tl). A location of the VM layer relative to the MPD layer and the BP layer may be altered to meet demands for different heat exchanger applications. By doing this, a cost of manufacturing a heat exchanger with properties of Cu may be decreased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a first embodiment of a processed braze sheet;

FIG. 2 shows a second embodiment of a processed braze sheet;

FIG. 3 shows a third embodiment of a processed braze sheet;

FIG. 4 shows a fourth embodiment of a processed braze sheet;

FIG. 5 shows a fifth embodiment of a processed braze sheet;

FIG. 6 shows a sixth embodiment of a processed braze sheet;

FIG. 7 shows a seventh embodiment of a processed braze sheet;

FIG. 8 shows an eighth embodiment of a processed braze sheet; and

FIG. 9 shows an example process for manufacturing the processed braze sheet.

### DETAILED DESCRIPTION

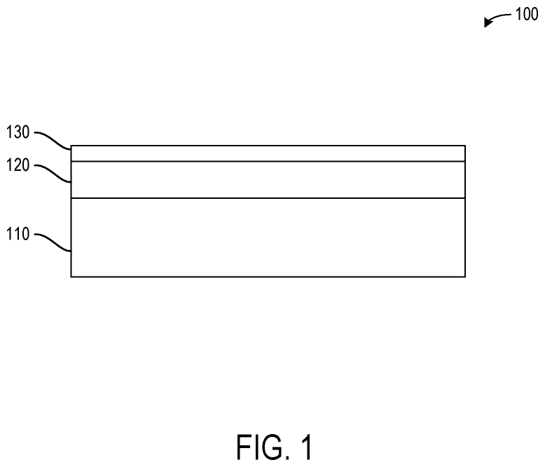

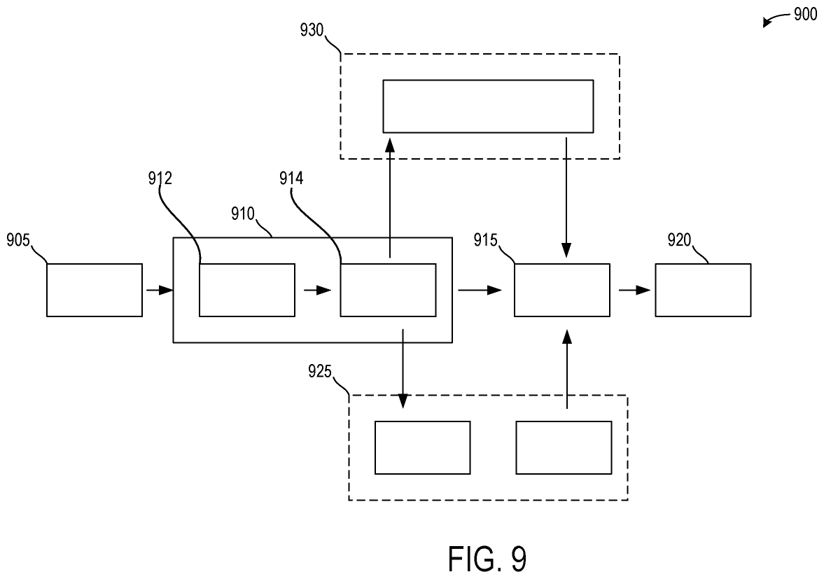

The following disclosure relates to a braze sheet. The disclosure provides support for different patterns of layers included in the processed braze sheet. Different processed braze sheet embodiments are shown in FIGS. 1-8. A manufacturing process of a processed braze sheet is shown in FIG. 9.

FIGS. 1-8 illustrate different examples of braze sheets including different numbers of layers and materials within each layer. The braze sheet may include a core Al sheet material that is laminated or “cladded” on one or both sides by filler metal in one sheet. The laminated or cladded filler metal may be interchangeably referred to as “clad”. Components may be cut and formed out of the braze sheet and assembled for brazing in a furnace, during which only the clad melts and forms the braze joints of the heat exchanger. Additionally or alternatively, heat exchanger components may also be formed out of “core” or “clad” material in separate sheets. Additional steps or precautions are also taken to deal with the tenacious aluminum oxide that otherwise would hinder the clad from flowing to form braze joints, e.g. Nocolok flux brazing, vacuum brazing, and Ni—Al brazing.

Nocolok flux brazing may include a non-hygroscopic and a non-corrosive potassium fluoroaluminate flux which removes an oxide film on aluminum, and does not react with aluminum in the molten or solid state and whose residue is only slightly soluble in water. Vacuum brazing may be similar to fluxless brazing, which may eliminate a demand for post-braze treatments. During fluxless and/or vacuum brazing, furnace temperatures, surface cleanliness, and atmospheric purity may be maintained within tight tolerances.

The disclosure provides support for a method of manufacture to produce an aluminum, optionally including an aluminum alloy, braze sheet for use in mixed metal brazing in a furnace brazing environment such as controlled atmosphere brazing or vacuum brazing. The processed braze sheet (PBS) may be used without additional treatment or protocols in standard controlled atmosphere brazing furnaces, such as belt furnaces with an inert nitrogen atmosphere, or vacuum furnaces. The PBS may be used to braze Al to Al, Cu to Al and/or Ni to Al, in combination and all at once in the furnace to produce mixed metal heat exchangers for a vehicle. Some embodiments of the processed braze sheet also allow fluxless brazing of mixed metal heat exchangers. Herein, the braze sheet may include an alloy of aluminum that may be cladded on one or both sides. The PBS may define a material that includes the braze sheet undergoing a plating operation, as will be described herein.

The PBS may include a plurality of layers overtop of an aluminum braze sheet, which includes at least one Al4000-series layer. During processing of the aluminum braze sheet, up to three layers are added to at least one side of the Al4000-series layer. The three layers may include a melting point depressant (MPD) layer including Cu, a braze promoting (BP) layer including Ni, Fe, or Co, and a viscosity and/or surface tension modifier (VM) layer including bismuth (Bi) and/or lead (Pb) and/or other low melting elements as known in the art such as tin (Sn), antimony (Sb), and thallium (Tl). The MPD layer is situated underneath the BP layer, while the VM layer may be closer to the aluminum layer than the MPD layer, between the MPD and BP layers, or farther from the aluminum layer than the BP layer.

The MPD layer may depress the solidus of the clad from 577° C. to approximately 525° C. due to the formation of ternary Al—Cu—Si eutectic. This layer permits the brazing of Al to Al, Cu to Al and/or Ni to Al at temperatures below the clad melting point of 577° C. and, notably in the case of Cu to Al, below the temperature of the binary Al—Cu eutectic temperature of 548° C. Therefore, at brazing temperatures above approximately 525° C., the MPD layer may diffuse into the clad layer between the MPD layer and the Al layer and form liquid metal Al—Cu—Si ternary eutectic in-situ, which acts as the brazing filler metal during brazing. It is possible to braze functional heat exchangers with only the MPD layer, however, including the VM layer and, in the case of fluxless brazing, also the BP layer may enhance the heat exchanger. Face-to-face contact between the MPD layer and the clad may promote a more stable formation of Al—Cu—Si ternary eutectic. Therefore, the layer deposition method may not involve intermediate steps that deposit coatings between the clad and MPD layer, e.g. zinc coating before copper plating in the case of a plating deposition process. The benefit of this PBS is that such intermediate layers or steps are not demanded for good brazing, thus reducing manufacturing costs.

The BP layer may tolerate oxides during brazing via the exothermic reaction between Ni and liquid Al at braze temperatures. In this way, the BP layer may promote fluxless brazing. While the ternary Al—Cu—Si eutectic liquid produced with the MPD layer alone may percolate through oxides during brazing (and form braze joints), the oxides may form continuous sheets (as opposed to being broken or digested into the clad) which may pose as nucleation sites for crack formation and subsequent propagation. The BP layer may eliminate this phenomenon and promote formation of strong braze joints. A secondary benefit of the BP layer may be to protect the MPD layer underneath from partially oxidizing either during the processing of the PBS, or oxidizing in the furnace atmosphere due to trace amount of oxygen. In addition, it is noted that the BP layer may further depress the solidus of the clad to approximately 520° C. due to the formation of quaternary Al—Cu—Si—Ni eutectic liquid.

One or more VM layers may be included to modify the viscosity and/or surface tension of the liquid metal once formed, which aids in the capillary action of the molten clad, and thus promotes its flow at brazing temperatures. The VM layer comprises one or more elements from the group bismuth (Bi), lead (Pb), tin, antimony, and thallium, but preferably Bi and/or Pb. It is noted that Bi and/or Pb may mitigate shrinkage porosity that would otherwise be observed, and thus promote the formation of continuous braze fillets, with benefits to joint life, strength, and corrosion resistance.

While an embodiment with the BP layer and the VM layer configured as separate layers is practical, flexible, and functional, it is found that it is economical to combine the BP and VM layers into a single layer overtop the MPD layer, which may be referred to herein as the BPVM layer. Thus, overtop the clad or Al4000-series layer may include two layers: the MPD in face-sharing contact with the clad or Al4000-series of the braze sheet, and the BPVM layer directly overtop the MPD layer. This embodiment provides all the aforementioned benefits with decreased manufacturing costs and complexity. A processed braze sheet with MPD, BP, VM, and/or BPVM layers may be used to braze heat exchangers in controlled atmosphere furnace brazing or vacuum brazing operations without further treatment.

Turning now to FIG. 1, it shows a first embodiment of a braze sheet 100. The braze sheet 100 may include a first layer 110, a second layer 120, and a third layer 130. The first layer 110 may be different than the second layer 120. The second layer 120 may be different than the third layer 130. The second layer 120 may be sandwiched between the first layer 110 and the third layer 130. In one example, a first face of the second layer 120 is in face-sharing contact with the first layer 110 and a second face of the second layer 120, opposite the first face, is in face-sharing contact with the third layer 130.

In one example, the first layer 110 is a core layer. The first layer 110 may include an aluminum sheet material that is laminated or “cladded” on at least a first surface with the second layer 120. The second layer 120 may be an alloy, different than the first layer 110, that may include a lower melting point than the first layer 110. The second layer 120 may include one or more alloys of Al, Cu, and silicon (Si).

In one example, the third layer 130 is a MPD layer including one or more of Cu, Bi, Pb, Sn, Sb, and Tl. The third layer 130 may be configured to decrease the melting point of the second layer 120.

In one example, the first layer is an alloy of aluminum sheet (e.g., Al3000 or Al6000 series layer), the second layer is a clad (e.g., Al4000 series layer), and the third layer is a sheet comprising Cu or another metal.

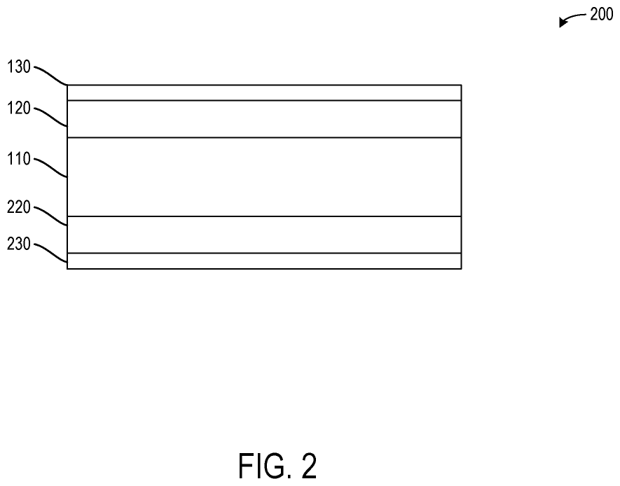

Turning now to FIG. 2, it shows a second embodiment of a second braze sheet 200. The second braze sheet 200 may include the first layer 110, the second layer 120, and the third layer 130. As such, components previously introduced may be similarly numbered in this and subsequent figures.

In one example, the second layer 120 is a first second layer 120, wherein the second braze sheet 200 further includes a second second layer 220, identical to the first second layer 120. The second second layer 220 is in face-sharing contact with an opposite side of the first layer 110 relative to the first second layer 120. As such, the first layer 110 is sandwiched between the first second layer 120 and the second second layer 220. In this way, the first layer 110 may be laminated on both of its long sides. In this way, both sides of the first layer 110 are cladded.

In one example, additionally or alternatively, the third layer 130 is a first third layer 130, wherein the second braze sheet 200 further includes a second third layer 230. The second third layer 230 may be identical to the first third layer 130. The second third layer 230 may be in face-sharing contact with the second second layer 220. In this way, the second second layer 220 is sandwiched between the first layer 110 and the second third layer 230.

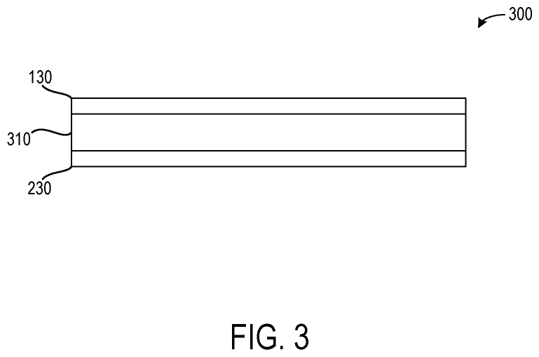

Turning now to FIG. 3, it shows a third embodiment of a third braze sheet 300. The third braze sheet 300 may include the first third layer 130, the second third layer 230, and a fourth layer 310. In one example, the fourth layer 310 is an aluminum-4000 series alloy.

In one example, the aluminum-4000 series layer may be an alloy of Al and Si included in the aluminum-4000 series, such as AL4343, Al4045, Al4047, and/or Al4150. The Si may depress the melting point of Al. For example, the melting point of Al may decrease from 660° C. to about 577° C. for 12.5 wt. % Si. Core Al alloys, such as the first layer 110 shown in FIGS. 1 and 2, may include Al3000 or Al6000 series alloys, such as Al3003 or Al6061. The core Al alloy may include less Si than the Al-4000 series layer or may be free of Si.

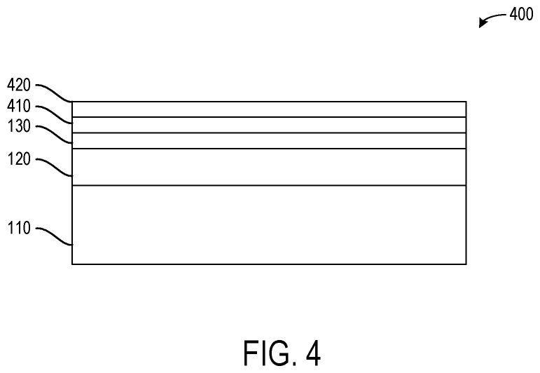

Turning now to FIG. 4, it shows a fourth embodiment of a fourth braze sheet 400. The fourth braze sheet 400 may be similar to the first braze sheet 100 of FIG. 1 in that the fourth braze sheet 400 includes the second layer 120 sandwiched between the first layer 110 and the third layer 130. Additionally, the first layer 110 is laminated on only one side via the second layer 120. The fourth braze sheet 400 may further include a fifth layer 410 and a sixth layer 420.

In one example, the fifth layer 410 may be a braze promoting (BP) layer. The sixth layer 420 may be a viscosity and/or surface tension modifying (e.g., VM) layer. The fifth layer 410 may include Ni and the sixth layer 420 may include one of more of Cu, Bi, Pb, Sn, Sb, and Tl. Additionally or alternatively, the fifth layer 410 may be a VM layer and the sixth layer 420 may be a BP layer.

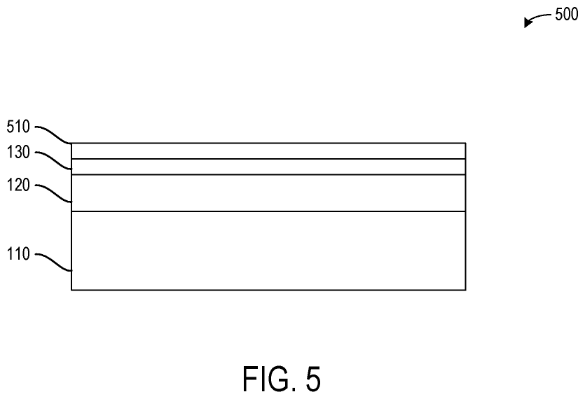

Turning now to FIG. 5, it shows a fifth embodiment of a fifth braze sheet 500. The fifth braze sheet 500 may be similar to the fourth braze sheet 400 in that it includes the first layer 110, the second layer 120, the third layer 130, a BP layer, and a VM layer. The fifth braze sheet 500 may be differentiated from the fourth braze sheet 400 in that a seventh layer 510 of the fifth braze sheet 500 includes a combination of the BP layer and the VM layer. In one example, the seventh layer 510 is a BPVM layer integrally including a mixture of the BP layer and the VM layer.

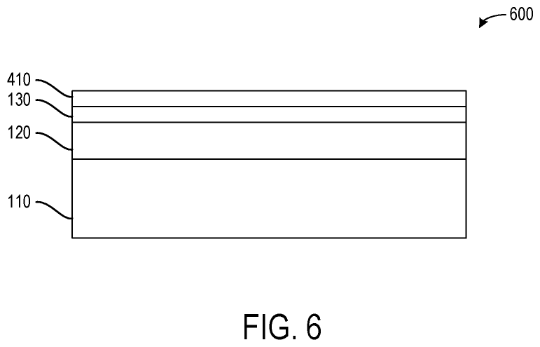

Turning now to FIG. 6, it shows a sixth embodiment of a sixth braze sheet 600. The sixth braze sheet 600 may be similar to the fourth braze sheet 400, except that the sixth braze sheet 600 does not include the sixth layer 420. As such, the fifth layer 410 may be in face-sharing contact with only the third layer 130 along a first face and exposed at a second face opposite the first face.

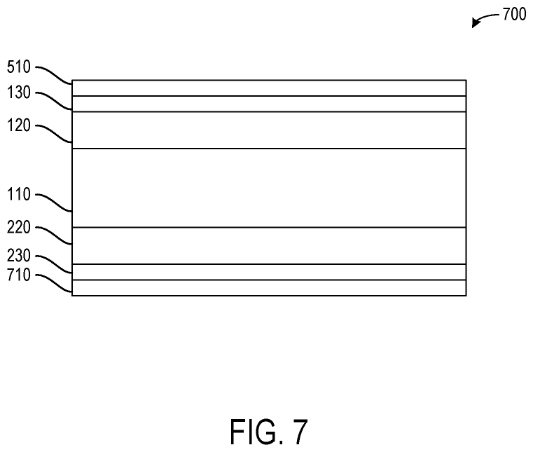

Turning now to FIG. 7, it shows a seventh embodiment of a seventh braze sheet 700. The seventh braze sheet 700 may be similar to the fifth braze sheet 500 in that it includes the first layer 110, the second layer 120, the third layer 130, and the seventh layer 510. The seventh braze sheet 700 may be differentiated from the fifth braze sheet 500 in that the first layer 110 is laminated on each of its long sides such that the seventh braze sheet 700 includes the first second layer 120 and the second second layer 220. The seventh braze sheet 700 may further include the first third layer 130 and the second third layer 230. The first second layer 120 is sandwiched between the first layer 110 and the first third layer 130. The second second layer 220 is sandwiched between the first layer 110 and the second third layer 230.

In one example, the seventh layer 510 is a first seventh layer 510, wherein the seventh braze sheet 700 further includes a second seventh layer 710. The first third layer 130 is sandwiched between the first second layer 120 and the first seventh layer 510. The second third layer 230 is sandwiched between the second second layer 220 and the second seventh layer 710. The first seventh layer 510 and the second seventh layer 710 are identical.

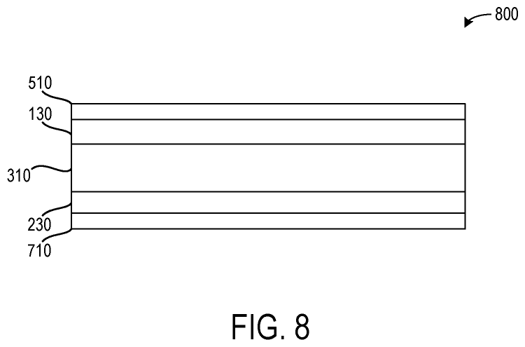

Turning now to FIG. 8, it shows an eighth embodiment of an eighth braze sheet 800. The eighth braze sheet 800 may be similar to the third braze sheet 300 in that it includes the fourth layer 310 sandwiched by the first third layer 130 and the second third layer 230. The eighth braze sheet 800 further includes the seventh layer 510 in face sharing contact with the first third layer 130. In this way, the first third layer 130 is in face-sharing contact with and sandwiched between the fourth layer 310 and the seventh layer 510.

In one example, the seventh layer 510 is a first seventh layer 510, wherein the eighth braze sheet 800 further includes a second seventh layer 710. The second seventh layer 710 may be in face-sharing contact with the second third layer 230. In this way, the second third layer 230 is sandwiched between the fourth layer 310 and the second seventh layer 710.

Starting with an aluminum brazing sheet, the MPD and BPVM layers are added to the clad or Al4000-series layer by plating, which schematically involves up to three steps. A first step may include a mechanical and/or chemical pre-treatment of the Al brazing sheet to remove any existing aluminum oxide. A second step may include direct plating of Cu to form the MPD layer. A third step may include subsequent plating of Ni with co-deposited Bi and/or Pb to form the BPVM layer. As alluded above, the Bi and/or Pb can be plated as one or more separate VM layers, but it may be more efficient to co-deposit Bi and/or Pb along with Ni to form the BPVM layer.

The thickness of the MPD layer may be at least 20 μ″ thick. The amount of liquid filler metal generated in-situ when brazing below 577° C. may be proportional to the thickness of the MPD layer, and greater thicknesses may be used for some liquid filler metals to form in-situ depending on the application.

A thickness of the BPVM layer may be at least 5 μ″. The Bi and/or Pb content in the BPVM layer may be up to 20 wt %. If Bi and/or Pb are in a separate VM layer, then a target thickness may be determined based on a thickness of the BP layer such that the Bi wt % or Pb wt % falls in the ranges indicated. If separate BP and VM layers are used, the Bi and/or Pb wt % of the combined BP and VM layers would also be up to 20%.

Post-braze wt % ranges for processed brazed sheet (PBS), based on amalgamated layers from the outside edge of the material to the core portion of the material for FIGS. 1-2, 4-7, and through the entire material for FIGS. 3 and 8 may include Cu: 0.4-37%, Ni (or Co or Fe): 0.08-16%, Pb or Bi (or Sn or Sb or Tl): 0.002-3.4%, Si: 3.5-13%, and a remainder including Al+impurities.

The processed braze sheet (PBS) can be used directly in controlled atmosphere furnace brazing or vacuum brazing processes.

When using the PBS for the brazing of Al to Al, the brazing may occur with a brazing temperature between approximately 530° C.-610° C. Therefore, the PBS of the present disclosure enables low temperature brazing of Al, below the melting point of other clad alloys such as Al4343, Al4045 and Al4047. The PBS may be used in products as a drop-in replacement for aluminum braze sheets used in automotive heat exchanger manufacturing.

The PBS also provides enhanced brazing of Cu directly to Al, optionally including alloys of Cu and/or Al, on a clad side or clad sides of the PBS, with a brazing temperature between 530° C.-560° C. As such, Cu components may be brazed with Al assemblies in one brazing operation using the PBS. For example, a Cu component such as a turbulizer or other extended heat transfer surface may be brazed with an Al heat exchanger assembly to benefit from the higher thermal conductivity of Cu without having to braze a heat exchanger including only Cu or Cu alloy components. The PBS therefore can provide significant cost and weight advantages in the manufacturing of automotive heat exchangers.

Additionally, Ni and/or its alloys may be brazed to the clad side(s) of the Al PBS where the brazing temperature may be between approximately 530° C.-610° C. This may be useful in applications in which components of the HX are Ni-coated prior to assembly and subsequent brazing, for example a Ni-coated Cu turbulizer.

Turning now to FIG. 9, it shows a processing routine 900 for manufacturing the processed braze sheet embodiments of FIGS. 1-8. A core sheet 905, such as the first layer 110, the fourth layer 310, and/or a braze sheet, may be pre-treated at 912 to clean oxides from the braze sheet. The braze sheet may be clad on a single side or on both sides and may be similar to only the fourth layer 310, a combination of the first layer 110 and the second layer 120, or a combination of the first layer 110, the second layer 120, and the second second layer 220. An MPD layer, such as the first third layer 130 or the second third layer 230, may be joined to the core sheet 905 at 914. In one example, the pre-treating and the MPD are applied to the braze sheet in a single step 910.

At 915, the sheet with the MPD (e.g., the PBS) may be stamped to form one or more components.

At 920, the components may be assembled with the stamped PBS and furnace brazed.

Prior to 915, if the BP and VM layers are desired, then the PBS may first be layered with a BP layer and then layered with a VM layer at 925, or vice versa. Adding the BP layer may include plating the MPD layer(s) with Ni and adding the VM layer may include plating the Ni layer(s) with Bi and/or Pb. Additionally or alternatively, a single BPVM may be plated onto the MPD layer(s) at 930.

Following 925 and/or 930, the braze sheet may be stamped and the resulting components may be assembled and brazed.

It will be appreciated that in embodiments where layers may be built up on one side of a starting layer of an Al sheet, it may be further possible that the same or different layers may also be built up on another side of the Al sheet. Some, but not all, envisioned examples of this have been included in the figures. Also, it is possible that multi-layer braze sheet (e.g., a starting material such as 4045/3003/4045) will be plated on only one side. Further, other scenarios include the possibility of the VM layer being above or below the BP layer, or between the MPD layer and the clad layer, even if these various scenarios are not specifically described.

The disclosure provides support for a system including a processed braze sheet (PBS) comprising at least a layer of aluminum (Al) or aluminum alloy with at least one side comprising a melting point depressant (MPD) layer comprising copper (Cu). A first example of the system further includes where the layer of Al is clad on at least one side with a metal alloy comprising a melting point lower than Al. A second example of the system, optionally including the first example, further includes where the layer of Al is Al4000-series comprising an alloy of Al and silicon (Si). A third example of the system, optionally including one or more of the previous examples, further includes where the MPD layer is coated with a braze promoting (BP) layer comprising one or more of nickel (Ni), cobalt (Co), and iron (Fe). A fourth example of the system, optionally including one or more of the previous examples, further includes where the BP layer is coated with a viscosity modifying (VM) layer comprising one or more of bismuth (Bi), lead (Pb), tin (Sn), antimony (Sb), and thallium (Tl). A fifth example of the system, optionally including one or more of the previous examples, further includes where the VM layer is between the MPD layer and the layer of Al. A sixth example of the system, optionally including one or more of the previous examples, further includes where the BP layer further comprises a viscosity modifying (VM) layer integrally arranged therein. A seventh example of the system, optionally including one or more of the previous examples, further includes where the MPD layer is between a VM layer and the layer of Al, the VM layer comprising one or more of bismuth (Bi), lead (Pb), tin (Sn), antimony (Sb), and thallium (Tl).

The disclosure provides additional support for a processed braze sheet (PBS) including a first layer clad along at least a first surface with a second layer, the first layer comprising at least aluminum (Al) and the second layer comprising a metal alloy with a melting point lower than Al and a third layer in face-sharing contact with the second layer, the third layer comprising copper (Cu). A first example of the PBS further includes where the second layer is a first second layer, and wherein the first layer is clad along a second surface with a second second layer. A second example of the PBS, optionally including the first example, further includes where the third layer is a first third layer, and wherein the second second layer is in face-sharing contact with a second third layer. A third example of the PBS, optionally including one or more of the previous examples, further includes where a braze promoting (BP) layer is in face-sharing contact with the third layer, the BP layer comprising one or more of nickel (Ni), Cobalt (Co), and iron (Fe). A fourth example of the PBS, optionally including one or more of the previous examples, further includes where the BP layer is in face-sharing contact with a viscosity modifying (VM) layer, the VM layer comprising one or more of bismuth (Bi), lead (Pb), tin (Sn), antimony (Sb), and thallium (Tl). A fifth example of the PBS, optionally including one or more of the previous examples, further includes where a viscosity modifying (VM) layer is integrally arranged within the BP layer, the VM layer comprising one or more of bismuth (Bi), lead (Pb), tin (Sn), antimony (Sb), and thallium (Tl). A sixth example of the PBS, optionally including one or more of the previous examples, further includes where the second layer further comprises silicon (Si).

The disclosure provides further support for a system including a processed braze sheet (PBS) configured for use by a heat exchanger, the PBS comprising a core layer comprising aluminum (Al), a melting point depressant (MPD) layer comprising copper (Cu) in face-sharing contact with a cladded side of the core layer, and one or more of a braze promoting (BP) layer and a viscosity modifying (VM) layer in face-sharing contact with the MPD layer. A first example of the system further includes where the BP layer comprises one or more of nickel (Ni), Cobalt (Co), and iron (Fe). A second example of the system, optionally including the first example, further includes where the VM layer comprises one or more of bismuth (Bi), lead (Pb), tin (Sn), antimony (Sb), and thallium (Tl). A third example of the system, optionally including one or more of the previous examples, further includes where the BP layer and the VM layer are combined and integrally arranged in a single BPVM layer. A fourth example of the system, optionally including one or more of the previous examples, further includes where the core layer is cladded on both sides, wherein the MPD layer is in face-sharing contact with both cladded sides.

FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example.

In the present disclosure, the layers described are mutually exclusive, non-overlapping layers. Materials of one layer may not be mixed or dispersed with materials of another layer, unless explicitly disclosed. Each layer may be defined by boundaries, wherein adjacent layers with boundaries contacting one another may be in face-sharing contact.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a processed braze sheet (PBS) comprising at least a layer of aluminum (Al) or aluminum alloy with at least one side comprising a melting point depressant (MPD) layer comprising copper (Cu).

2. The system of claim 1, wherein the layer of Al is clad on at least one side with a metal alloy comprising a melting point lower than Al.

3. The system of claim 1, wherein the layer of Al is Al4000-series comprising an alloy of Al and silicon (Si).

4. The system of claim 1, wherein the MPD layer is coated with a braze promoting (BP) layer comprising one or more of nickel (Ni), cobalt (Co), and iron (Fe).

5. The system of claim 4, wherein the BP layer is coated with a viscosity modifying (VM) layer comprising one or more of bismuth (Bi), lead (Pb), tin (Sn), antimony (Sb), and thallium (Tl).

6. The system of claim 5, wherein the VM layer is between the MPD layer and the layer of Al.

7. The system of claim 4, wherein the BP layer further comprises a viscosity modifying (VM) layer integrally arranged therein.

8. The system of claim 4, wherein the MPD layer is between a VM layer and the layer of Al, the VM layer comprising one or more of bismuth (Bi), lead (Pb), tin (Sn), antimony (Sb), and thallium (Tl).

9. A processed braze sheet (PBS), comprising:
a first layer clad along at least a first surface with a second layer, the first layer comprising at least aluminum (Al) and the second layer comprising a metal alloy with a melting point lower than Al;
a third layer in face-sharing contact with the second layer, the third layer comprising copper (Cu).

10. The PBS of claim 9, wherein the second layer is a first second layer, and wherein the first layer is clad along a second surface with a second second layer.

11. The PBS of claim 10, wherein the third layer is a first third layer, and wherein the second second layer is in face-sharing contact with a second third layer.

12. The PBS of claim 9, wherein a braze promoting (BP) layer is in face-sharing contact with the third layer, the BP layer comprising one or more of nickel (Ni), Cobalt (Co), and iron (Fe).

13. The PBS of claim 12, wherein the BP layer is in face-sharing contact with a viscosity modifying (VM) layer, the VM layer comprising one or more of bismuth (Bi), lead (Pb), tin (Sn), antimony (Sb), and thallium (Tl).

14. The PBS of claim 12, wherein a viscosity modifying (VM) layer is integrally arranged within the BP layer, the VM layer comprising one or more of bismuth (Bi), lead (Pb), tin (Sn), antimony (Sb), and thallium (Tl).

15. The PBS of claim 9, wherein the second layer further comprises silicon (Si).

16. A system, comprising:
a processed braze sheet (PBS) configured for use by a heat exchanger, the PBS comprising a core layer comprising aluminum (Al), a melting point depressant (MPD) layer comprising copper (Cu) in face-sharing contact with a cladded side of the core layer, and one or more of a braze promoting (BP) layer and a viscosity modifying (VM) layer in face-sharing contact with the MPD layer.

17. The system of claim 16, wherein the BP layer comprises one or more of nickel (Ni), Cobalt (Co), and iron (Fe).

18. The system of claim 16, wherein the VM layer comprises one or more of bismuth (Bi), lead (Pb), tin (Sn), antimony (Sb), and thallium (Tl).

19. The system of claim 16, wherein the BP layer and the VM layer are combined and integrally arranged in a single BPVM layer.

20. The system of claim 16, wherein the core layer is cladded on both sides, wherein the MPD layer is in face-sharing contact with both cladded sides.
